(19) United States
(12) Patent Application Publication
(10) Pub. No.: US 2010/0269618 A1
(43) Pub. Date: Oct. 28, 2010

(54) POWER TRANSMISSION DEVICE WITH BEVEL GEAR

(75) Inventor: Akira YAMAMOTO, Obu-shi (JP)

Correspondence Address: SQUIRE, SANDERS & DEMPSEY L.L.P., 8000 TOWERS CRESCENT DRIVE, 14TH FLOOR, VIENNA, VA, 22182-6212, US

(73) Assignee: SUMITOMO HEAVY INDUSTRIES, LTD., Tokyo (JP)

(21) Appl. No.: 12/833,276

(22) Filed: Jul. 9, 2010

Related U.S. Application Data
(63) Continuation of application No. PCT/JP2009/050718, filed on Jan. 20, 2009.

(30) Foreign Application Priority Data
Jan. 25, 2008 (JP) 2008-15338

(51) Int. Cl. F16H 1/02; F16H 57/02

(52) U.S. Cl. 74/459.5

(57) ABSTRACT

Provided is a power transmission device with a bevel gear for supporting a bevel gear or a shaft with the bevel gear through a bearing. The bearing solely has a structure in which its rolling elements support without play a thrust load in both directions of the bevel gear or the shaft with the bevel gear. A pitch circle of each of the rolling elements may be located on the outside of an inner end of a tooth of the bevel gear in the radial direction.

### BACKGROUND OF THE INVENTION

1. Field of the Invention

The present invention relates to a power transmission device with a bevel gear such as a hypoid gear.

Priority is claimed on Japanese Patent Application No. 2008-15338, filed on Jan. 25, 2008, the content of which is incorporated herein by reference.

2. Description of the Related Art

For example, the publication of JP-A-2004-301234 discloses a power transmission device with a hypoid gear as shown in FIG. 6.

In the power transmission device 10, a rotation of a motor shaft 12 is transmitted to a hypoid pinion (bevel gear) 14 through a friction coupling portion 13. The hypoid pinion 14 engages with a hypoid gear (bevel gear) 16. The hypoid gear 16 is assembled to an intermediate shaft 18 through a key 17. The intermediate shaft 18 is supported to a casing 24 through a pair of ball bearings 20 and 22. The intermediate shaft 18 is provided with an intermediate pinion 26, and the intermediate pinion 26 engages with an output gear 28. The output gear 28 is integrated with an output shaft 32 through a key 30.

### SUMMARY OF THE INVENTION

According to an embodiment of the present invention, there is provided a power transmission device with a bevel gear for supporting a bevel gear or a shaft with the bevel gear through a bearing, wherein the bearing has a structure in which its rolling elements support without play a thrust load in both directions of the bevel gear or the shaft with the bevel gear, and wherein a pitch circle of each of the rolling elements is located on the outside of an inner end of a tooth of the bevel gear in the radial direction.

### BRIEF DESCRIPTION OF THE DRAWINGS

FIG. 1 is a plan cross-sectional view showing a power transmission device with a bevel gear according to an embodiment of the invention.

FIG. 2 is a front cross-sectional view thereof.

FIG. 3 is an enlarged view showing a main part of FIG. 1.

FIG. 4 is a plan cross-sectional view corresponding to FIG. 1 and showing the power transmission device with the bevel gear according to another embodiment of the invention.

FIG. 5 is a front cross-sectional view thereof.

FIG. 6 is a plan cross-sectional view corresponding to FIG. 1 and showing an example of a power transmission device with a bevel gear according to a related art.

### DETAILED DESCRIPTION OF THE INVENTION

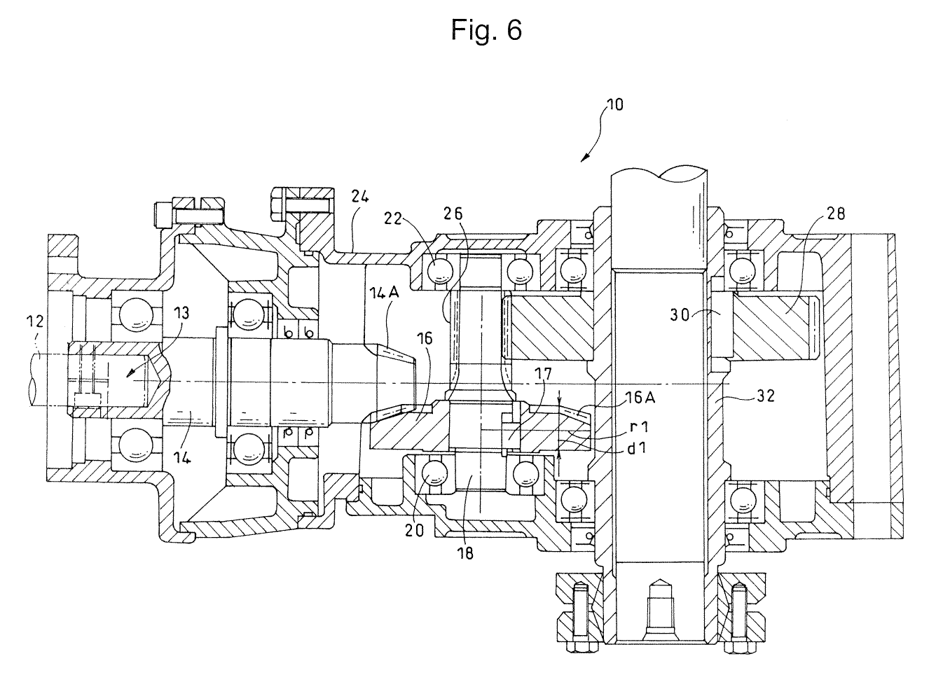

In the bevel gear (in the above-described example shown in FIG. 6, the hypoid pinion 14 and the hypoid gear 16), appropriate backlash needs to be maintained between the hypoid pinion 14 and the hypoid gear 16 in order to maintain the smooth engagement therebetween. In the power transmission device 10, for this purpose, first a first shim alignment is performed between the casing 24 and the ball bearing 20 (or the ball bearing 22) so that appropriate backlash is ensured at the axial position between the intermediate shaft 18 having the hypoid gear 16 assembled thereto and the hypoid pinion 14. Then, a second shim alignment is performed between the ball bearing 22 (or the ball bearing 20) and the casing 24 so that the axial position of the intermediate shaft 18 (having appropriately adjusted backlash) with respect to the casing 24 is fixed and maintained.

In addition, since there is slight play (rattling) in the ball bearings 20 and 22 even in the assembled state after performing two stages of shim adjustment, the play may be accumulated. For example, in the case where the backlash between the hypoid gear 16 and the hypoid pinion 14 is reduced by the appropriate adjustment, there is a problem in that a smooth rotation may be degraded (particularly when the backlash is set to a small value substantially equal to a threshold).

In addition, particularly, in the case where the strength of the hypoid gear 16 is low, that is, in the above-described example, for example, an axial thickness d1 is small compared with an outer diameter r1 of the hypoid gear 16, the entire gear is deformed by a load, which may cause a phenomenon (a phenomenon referred to as so-called “collapse”) in which a tooth 16A of the hypoid gear 16 moves away from a tooth 14A of the hypoid pinion 14. For example, when the backlash is increased by the play of the ball bearings 20 and 22 and the collapse phenomenon occurs, an appropriate engagement state may not be ensured.

Due to such circumstances, in order to ensure appropriate backlash between the hypoid pinion 14 and the hypoid gear 16 in an appropriate engagement state, it is necessary to carefully cope with the first and second shim adjustments.

It is desirable to provide a power transmission device with a bevel gear capable of preventing the occurrence of a so-called collapse phenomenon of a hypoid gear and maintaining appropriate backlash only by a simple adjustment.

In the embodiment, the thrust load in both directions involved with the bevel gear or the shaft with the bevel gear may be basically supported only by one bearing. Also, the pitch circle of the rolling elements may be located on the outside of the inner end of the tooth of the bevel gear in the radial direction. For this reason, the adjustment of the backlash may be performed only at one position. In addition, in the bearing (having a function in which only one bearing positions the bevel gear or the shaft with the bevel gear in any side of the axial direction), it is designed that only one bearing copes with an oscillation component (moment) as a result of the function (if necessary). Further, since the pitch circle of the rolling element of the bearing is set to be large compared with the outer diameter of the bevel gear, it is possible to prevent occurrence of “a phenomenon of collapse”. Also, since the oscillation component can be effectively supported only by the bearing, it is possible to maintain high rigidity in the periphery of the bearing.

With such improved advantages, the positions of the teeth of the bevel gear are always set to a predetermined position of the opposite bevel gear, and hence the backlash is always maintained at a predetermined value. Accordingly, it is possible to set the setting value of the backlash to be small (if necessary), and thus to simultaneously realize a smooth rotation and high positioning precision.

As a result, it is possible to obtain a power transmission device with a bevel gear capable of ensuring and adjusting appropriate backlash of the bevel gear, and maintaining appropriate backlash and engagement regardless of the normal or reverse direction and the magnitude of a load.

Hereinafter, exemplary embodiments of the invention will be described in detail with reference to the drawings.

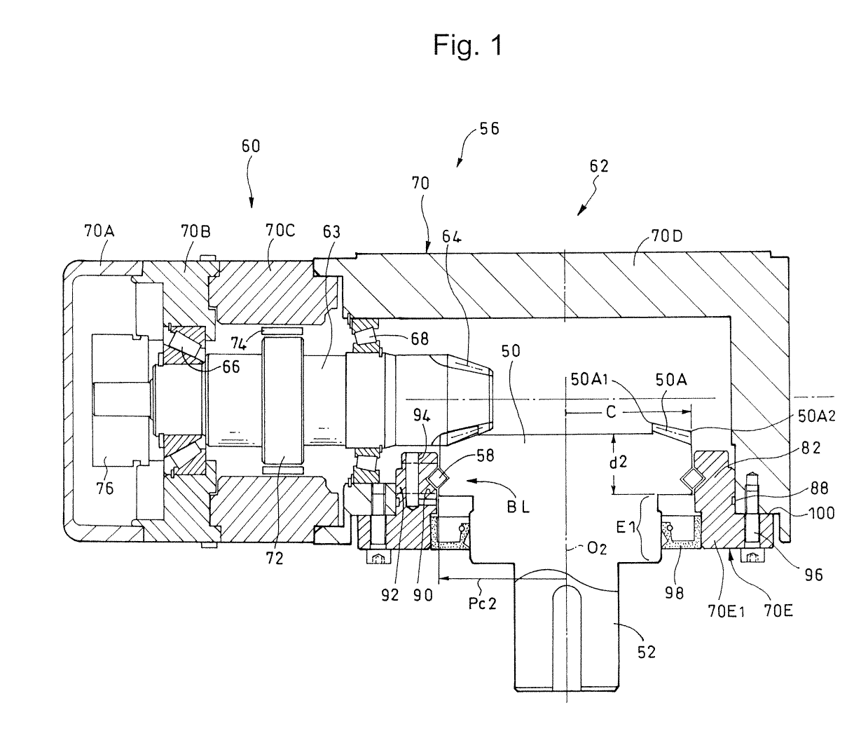

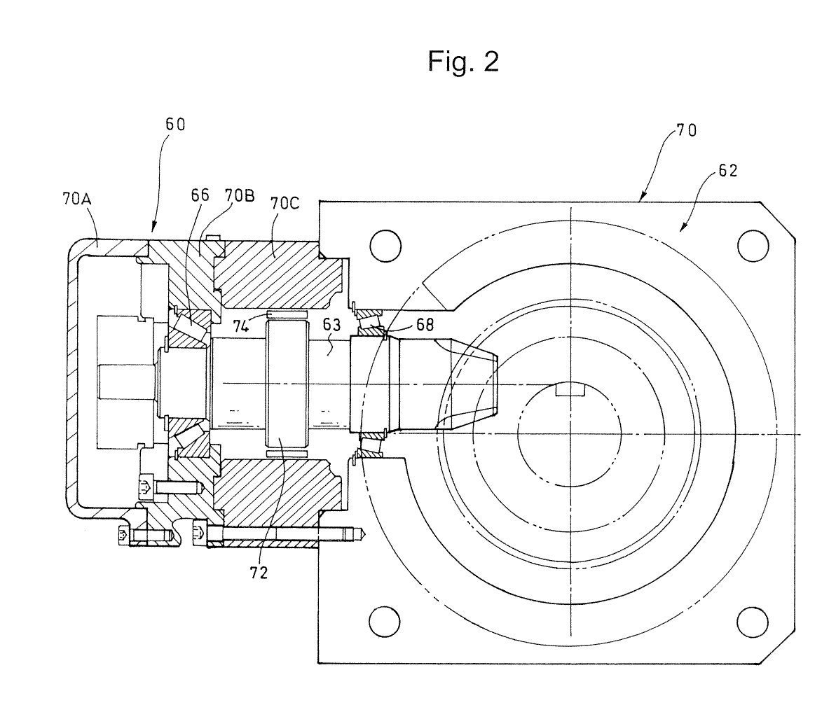

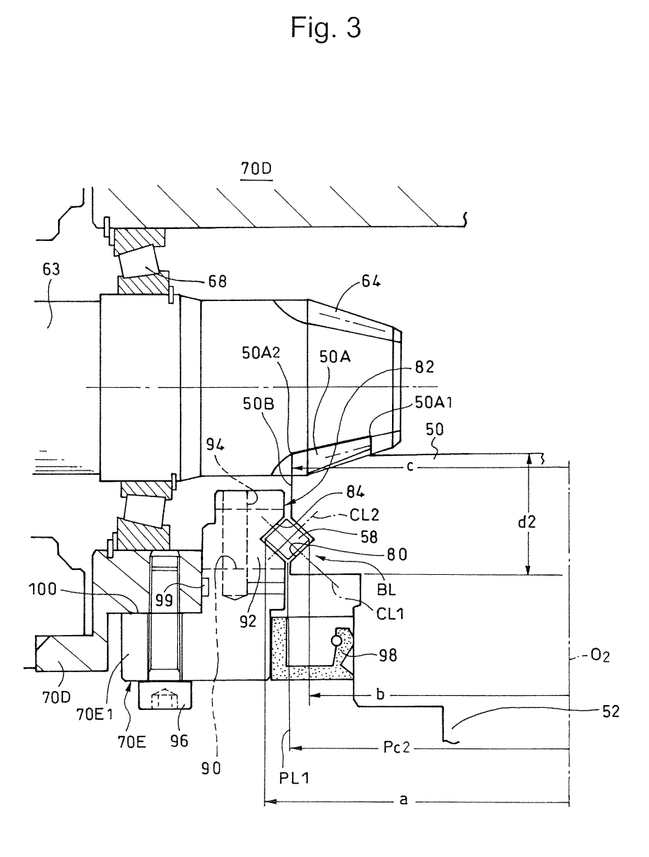

FIG. 1 is a plan cross-sectional view of a power transmission device with a hypoid gear (bevel gear) according to an example of the embodiments of the invention, FIG. 2 is a front cross-sectional view thereof, and FIG. 3 is an enlarged view of a main part of FIG. 1.

In the embodiment, a hypoid gear (bevel gear) 50 or a power transmission device 56 supporting a shaft (output shaft) 52 integrated with the hypoid gear 50 through a bearing BL is described. The bearing BL has a structure (cross roller bearing structure) in which its roller (rolling element) 58 supports without play a thrust load in both directions in the hypoid gear 50, and a pitch circle Pc2 of the roller (rolling element) 58 is located on the outside of an inner end 50A1 of a tooth 50A of the hypoid gear 50 in the radial direction. In the embodiment, the shaft integrated with the hypoid gear 50 directly serves as the output shaft 52.

Hereinafter, the entire configuration of the device will be described.

The power transmission device 56 includes a motor 60 and a decelerator 62. A front end of a motor shaft 63 of the motor 60 is integrally formed with a hypoid pinion (bevel gear on the other side) 64. The motor shaft 63 is rotatably supported to a casing 70 through tapered roller bearings 66 and 68 without “rattling”. In the embodiment, the casing 70 includes an end cover 70A, a motor side casing 70B, a motor body casing 70C, a decelerator body casing 70D, and a decelerator cover 70E.

The motor 60 mainly includes a rotor 72 which is integrated with the motor shaft 63, a permanent magnet 74 which is assembled to the outer periphery of the rotor 72, and an armature coil (not shown) which is integrated with the motor body casing 70C. In addition, the reference numeral 76 indicates a resolver for controlling the rotation. The resolver 76 is able to exhibit its function even under the presence of oil. In the power transmission device 56, the resolver 76 introduces oil inside the decelerator 62 to the inside of the motor 60 so as to lubricate the tapered roller bearings 66 and 68.

As shown in FIG. 3, a first concave portion 80 having an isosceles triangle section is circumferentially provided in a part of the outer periphery of the hypoid gear 50. In addition, a part (specifically, a part of the decelerator cover 70E) of the casing 70 of the power transmission device 56 is provided with a facing portion 82 facing a part of the outer periphery of the hypoid gear 50, and a second concave portion 84 having an isosceles triangle section is circumferentially provided at a position facing the first concave portion 80 of the facing portion 82. Then, a plurality of cylindrical rollers 58, of which the diameter is equal to the axial length and which uses the first and second concave portions 80 and 84 as transfer surfaces, is assembled between the first and second concave portions 80 and 84 so that the axes CL1 and CL2 (each roller (58) having the axis CL2 is not shown in FIG. 3) deviate from each other in a direction perpendicular to each other. This configuration forms a bearing structure of a so-called cross roller bearing, and the roller 58 has a single orbit surface PL1 so as to support not only the radial load, but also the thrust load in both directions.

As obviously shown in FIGS. 1 to 3, in the embodiment, a part of the outer periphery of the hypoid gear 50 also serves as the inner race of the bearing BL. In addition, a part of the inner periphery of the facing portion 82 of the casing 70 (specifically, the decelerator cover 70E) of the power transmission device 56 also serves as the outer race of the bearing BL.

Since the cross roller bearing has a structure in which the rollers 58 roll on the first and second concave portions 80 and 84 as the transfer surfaces while coming into line contact therewith, elastic displacement caused by the bearing load is small, and thus the diameter of the roller 58 is set not to have play, thereby setting the axial position of the hypoid gear 50 corresponding to the inner race at “one point” by using the decelerator cover 70E corresponding to the outer race. That is, the thrust load in both directions can be supported in addition to the radial load of the hypoid gear 50.

Here, assuming that a distance from the axis O2 of the hypoid gear 50 to the outermost periphery of the roller 58 is denoted by a, a distance from the axis O2 to the innermost periphery of the roller 58 is denoted by b, and a distance from the axis O2 to the outer end of the hypoid gear 50 is denoted by c, the size, etc. of the constituents are set so as to satisfy a relationship that (a+b)/2 (in this example, the dimension is equal to the pitch circle Pc2 of the roller 58) is larger (closer to the outside in the radial direction) than the distance C. In other words, in the embodiment, in order to satisfy the relationship of (a+b)>c, the axial thickness d2 of the hypoid gear 50 is set to be large. Then, the first concave portion 80 is formed in a sufficiently large portion of the outer periphery 50B, and the rollers (rolling elements) 58 are directly arranged by using the first concave portion 80 as the transfer surface. As a result, the pitch circle Pc2 of the roller 58 can be located farther outside than the outer end 50A2 of the tooth 50A of the hypoid gear 50 in the radial direction.

In the embodiment, the output shaft 52 including the hypoid gear 50 is only supported by the bearing BL. In addition, the adjustment of the backlash is performed by adjusting the thickness of a shim 100 disposed between the decelerator body casing 70D and the decelerator cover 70E.

In addition, in FIG. 3, the reference numeral 90 indicates a perforation hole to which the roller 58 is assembled one by one from the outside of the decelerator cover 70E in the radial direction in the state where the first concave portion 80 and the second concave portion 84 face each other. The reference numeral 92 indicates a cover which closes the perforation hole 90 after the roller 58 is assembled, and the reference numeral 94 indicates a pin which is inserted so as to prevent the separation of the cover 92. In addition, the reference numeral 96 indicates a bolt which connects the decelerator body casing 70D to the decelerator cover 70E, and the reference numeral 98 indicates an oil seal. Further, the reference numeral 99 indicates an O-ring which seals the inside and outside of the decelerator 62.

Next, the operation of the power transmission device 56 will be described.

In the embodiment, since the motor shaft 63 and the hypoid pinion 64 are integrated with the rotor 72 of the motor 60, the rotation of the rotor 72 of the motor 60 is directed used as the rotation of the hypoid pinion 64. Since the hypoid pinion 64 engages with the hypoid gear 50 so that the hypoid gear 50 is integrated with the output shaft 52, the rotation of the hypoid gear 50 is directly output as the rotation of the output shaft 52.

Here, the hypoid gear 50 has a bearing of a so-called cross roller bearing structure. That is, the bearing has a structure in which the roller 58 as the rolling element has a single orbit surface PL1, and is able to support the thrust load in both directions in addition to the radial load. Also, the pitch circle Pc2 of the roller 58 is located farther outside than the outer end 50A2 of the tooth 50A of the hypoid gear 50 in the radial direction. For this reason, the axial position of the hypoid gear 50 can be assembled and fixed to a desired point only by one bearing BL (without rattling).

In the assembling operation, the adjustment of the backlash and the axial positioning operation of the hypoid gear 50 (output shaft 52) with respect to the casing 70 (specifically, the decelerator cover 70E) can be simultaneously completed by the adjustment of the thickness of the shim 100 at one position, for example, between a flange portion 70E1 of the decelerator cover 70E and the decelerator body casing 70D.

The axial thickness d2 of the hypoid gear 50 is set to be relatively larger than the dimension c from the axis of the hypoid gear 50 to the outer end 50A2 of the hypoid gear 50. In addition, since the hypoid gear 50 has a large diameter satisfying the relationship of (a+b)>c and has the bearing BL assembled thereto and immovable in the axial direction, the collapse caused by the operation of engaging the hypoid pinion 64 with the hypoid gear 50 is prevented, and hence the rigidity in the periphery of the hypoid gear 50 is extremely large.

As a result, since the backlash between the hypoid pinion 64 and the hypoid gear 50 is adjusted by the adjustment of the thickness of the shim 100 only at one position, the adjusted backlash may be appropriately maintained regardless of a variation in load or a rotation direction. Accordingly as necessary, by setting the backlash to be small so that it is close to the limit, it is possible to obtain high positioning precision without degrading the smoothness of the rotation.

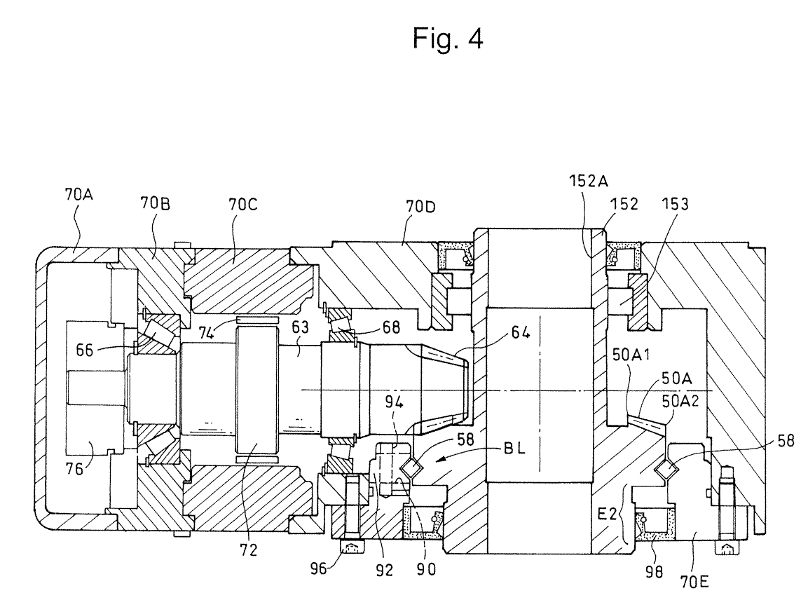

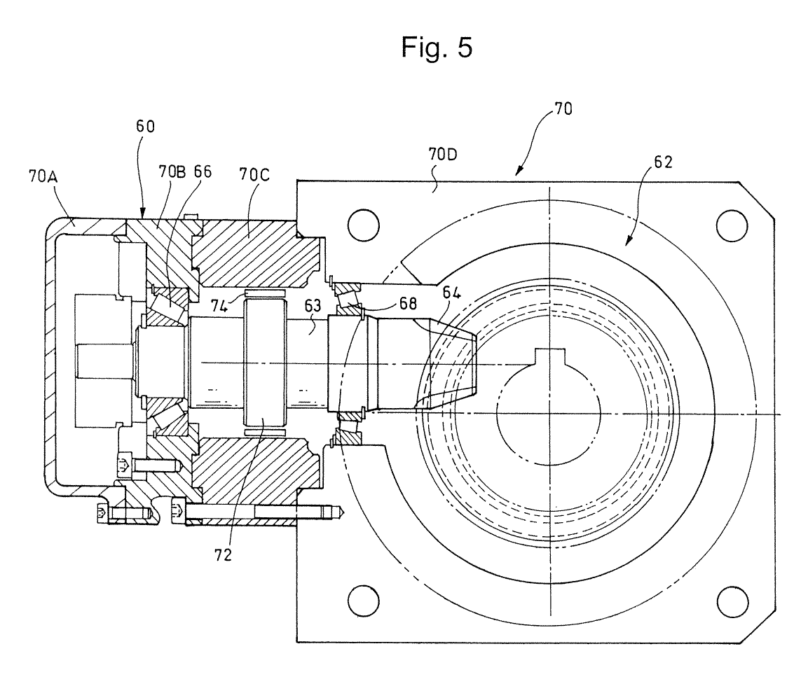

Next, an example of another embodiment of the invention will be described with reference to FIGS. 4 and 5.

In the embodiment, the basic power transmission path is the same as that of the above-described embodiment, but has a configuration in which the shaft constituting the hypoid gear 50 is formed as a hollow output shaft 152, and a driven shaft of a relative machine (not shown) is fitted into a hollow portion 152A of the hollow output shaft 152 so as to transmit power. A roller bearing 153 is assembled to the other end of the hollow output shaft 152 so as to receive a load of the hollow output shaft 152. However, the roller bearing 153 is not involved with the axial positioning operation of the hollow output shaft 152. For this reason, after ensuring appropriate backlash between the hypoid pinion 64 and a hypoid gear 50, the axial positioning operation of the hollow output shaft 152 is performed in the same manner as the above-described embodiment by using the bearing BL having the same configuration as that of the above-described embodiment.

Since the other configurations are the same as those of the above-described embodiment, the same reference numerals as those of the above-described embodiment are given to the same or substantially same constituents in the drawings, and the repetitive description thereof is omitted.

In addition, in the above-described embodiment, the pitch circle Pc2 of the roller (rolling element) 58 is located to be on the outside of the outer end 50A2 of the tooth 50A of the hypoid gear in the radial direction, but in the invention, the pitch circle need not be essentially enlarged to the position. That is, when the pitch circle is located on the outside of the inner end 50A1 of the tooth of the hypoid gear (bevel gear) in the radial direction, a desired object of the invention can be achieved. In other words, regarding the arrangement position of the rolling element, for example, according to the above-described embodiment, since the outer diameter of the portion of the axial range E1 (FIG. 1) or E2 (FIG. 4) is located on the outside of the inner end (50A1) of the tooth of the bevel gear in the radial direction, the bearing may be disposed at the position of the axial range E1 (FIG. 1) or E2 (FIG. 4).

Further, in the above-described embodiment, the number of constituents is decreased by a configuration in which a part of the outer periphery of the bevel gear also serves as the inner race of the bearing, and a part of the inner periphery of the casing of the power transmission device also serves as the outer race of the bearing. However, the bearing according to the invention may have an exclusive inner or outer race.

Furthermore, in the above-described embodiment, the invention is applied to the hypoid gear, but the bevel gear according to the invention is not limited thereto. That is, the invention may be applied to the hypoid pinion, or may be also applied to a so-called bevel gear in which the axes of two bevel gears intersect each other on a single plane.

Moreover, when the function of supporting thrust in both directions of the bevel gear or the shaft with the bevel gear is interpreted in a broad sense, for example, a structure may be supposed in which the inner and outer races of the ball bearing are restrained in the axial direction. However, in a general ball bearing, the rolling element comes into contact with each of the inner and outer races only at one point (two points in total), and there is play in the axial direction due to the nature of the structure. For example, when the direction of the thrust load is changed due to a change of the rotation direction, the shaft moves in the axial direction by a degree corresponding to the play thereof. Accordingly, in the ball bearing with such a general structure, it is hard to say that the bearing is able to satisfactorily achieve the object of the invention, and the concept of “a bearing having a function capable of supporting without play a thrust load in both directions” is not included. From this view point, the bearing according to the invention needs to have a configuration in which the rolling element and each of the inner and outer races come into contact with each other at least three points in total (for example, a three point contact ball bearing), come into contact with each other at two points, that is, four points in total (a four point contact ball bearing), or come into contact with each other at two lines obtained by changing angles thereof as the above-described embodiment (a cross roller bearing). With such a configuration, the rolling element is able to come into contact with the inner and outer races without play in the axial direction, and hence the object of the invention can be realized.

In addition, examples of a bearing apparently formed as one bearing and having a function of supporting a thrust load in both directions include, for example, a double row angular ball bearing, a double row conical roller bearing, a self aligning roller bearing, etc. In such a bearing, two or more orbit surfaces for rolling elements are provided in the inner or outer race, but the same advantage as the bearing of the invention is obtained. Accordingly, in the invention, since even such “a bearing having a plurality of orbit surfaces for rolling elements” is concluded as a single bearing, the bearing is not particularly excluded from the application target of the invention if the bevel gear or the shaft with the bevel gear is able to be supported without play (rattling) in any axial direction, that is, a thrust load in both directions can be supported without play. However, since such a bearing having two or more orbit surfaces is disadvantageous from the viewpoint of the cost, weight, and occupying volume, it is more desirable that the orbit surface for the rolling elements is formed in one bearing as in the above-described embodiment.

Further, according to the above-described embodiment, the bevel gear (hypoid gear) and the shaft with the bevel gear are integrated as the output shaft, but in the invention, the bevel gear and the shaft with the bevel gear may not be essentially integrated with each other.

The power transmission device with the bevel gear is applicable to various purposes.

It should be understood that the invention is not limited to the above-described embodiment, but may be modified into various forms on the basis of the spirit of the invention. Additionally, the modifications are included in the scope of the invention.

What is claimed is:

1. A power transmission device with a bevel gear for supporting a bevel gear or a shaft with the bevel gear through a bearing,
wherein the bearing solely has a structure in which its rolling elements support without play a thrust load in both directions of the bevel gear or the shaft with the bevel gear, and
wherein a pitch circle of each of the rolling elements is located on the outside of an inner end of a tooth of the bevel gear in the radial direction.

2. The power transmission device according to claim 1,
wherein the bearing is a cross roller bearing.

3. The power transmission device according to claim 1,
wherein assuming that a distance from an axis of the bevel gear to an outermost periphery of the rolling element is denoted by a, a distance from the axis of the bevel gear to an innermost periphery of the rolling element is denoted by b, and a distance from the axis of the bevel gear to an outer end of the tooth of the bevel gear is denoted by c, the rolling element is disposed at a position satisfying a+b>c.

4. The power transmission device according to claim 1,
wherein a part of the outer periphery of the bevel gear or the shaft with the bevel gear also serves as an inner race of the bearing.

5. The power transmission device according to claim 1,
wherein a part of an inner periphery of a casing of the power transmission device also serves as an outer race of the bearing.

6. The power transmission device according to claim 1,
wherein the bevel gear or the shaft with the bevel gear is supported only by the bearing.

7. The power transmission device according to claim 1,
wherein a first concave portion having an isosceles triangle section is circumferentially provided in a part of the outer periphery of the bevel gear or the shaft with the bevel gear,
wherein a facing portion facing the first concave portion is provided at a part of the casing of the power transmission device, and a second concave portion having an isosceles triangle section is circumferentially provided at a position facing the first concave portion of the facing portion, and
wherein a plurality of cylindrical rollers each having a diameter and an axial length equal to each other is assembled between the first and second concave portions while using the first and second concave portions as transfer surfaces and allowing the axes thereof to deviate from each other in a direction perpendicular to each other.
